(19) United States
(12) Patent Application Publication
(10) Pub. No.: US 2025/0094274 A1
(43) Pub. Date: Mar. 20, 2025

(54) EXCEPTION RESET MONITORING METHOD FOR MULTI-CORE MICRO CONTROL UNIT

(71) Applicants: SHANGHAI LEEKR TECHNOLOGY CO.LTD., Shanghai (CN); SUZHOU LEEKR TECHNOLOGY CO.LTD., Suzhou (CN)

(72) Inventors: Zhifeng HUI, Shanghai (CN); Ganting SU, Shanghai (CN); Hongqing FANG, Shanghai (CN); Youkun LI, Shanghai (CN)

(21) Appl. No.: 18/594,953

(22) Filed: Mar. 4, 2024

Related U.S. Application Data
(63) Continuation of application No. PCT/CN2023/138191, filed on Dec. 12, 2023.

(30) Foreign Application Priority Data
Sep. 15, 2023 (CN) 202311188128.0

(51) Int. Cl. G06F 11/10; G06F 11/07

(52) U.S. Cl. CPC G06F 11/1004; G06F 11/0775; G06F 11/079

(57) ABSTRACT

An exception reset monitoring method for a multi-core micro control unit includes acquiring exception program information of a corresponding program exception site after detecting that one processing core in a multi-core micro control unit has entered an exception program branch; writing processing core identity information and the exception program information into a specified storage area of a non-clear random access memory. The exception reset monitoring method for a multi-core micro control unit is designed with the non-clear random access memory to allow that when an exception occurs during run of a whole program, exception information generated can be stored in a specified area of the non-clear random access memory for data protection, and data in a protected area will not be cleared during subsequent reset.

### CROSS REFERENCE TO RELATED APPLICATIONS

This application is a Continuation of the U.S. National Stage of International Application No. PCT/CN2023/138191 filed on Dec. 12, 2023, which claims priority to Chinese Patent Application No. 202311188128.0 on filed Sep. 15, 2023 under 35 U.S.C. § 119; the entire contents of all of which are hereby incorporated by reference.

### TECHNICAL FIELD

The present application relates to the technical field of microcontrollers, and particularly relates to an exception reset monitoring method and device for a multi-core micro control unit.

### BACKGROUND

At present, in an automotive controller, when an exception occurs during run of an MCU system due to improper use of MCU resources by a user or a fault of a MCU itself, software will enter an exception program (TRAP) branch. At this time, a usual software practice is to reset the software (passive reset) to a normal state by watchdog timeout. Fault information is recorded in a read-only memory (ROM), i.e., an NVM module of AUTOSAR standard, by some designers before the software is reset, and then the MCU is reset, so that it is easy to query a fault cause after reset.

The problems with this are as follows: 1. generation of a TRAP may be caused by an error of the NVM itself (or submodules MemIf, Fee and Fls thereof); in fact, such error is very common; and in this case, operating the NVM may cause a new fault; 2. such a method of passive reset by a watchdog consumes a long time, usually tens or even hundreds of milliseconds, and the operation of the NVM itself also consumes time (especially at the time of Fee sector switching), which is not conducive to rapid fault recovery of the MCU; 3. in a multi-core MCU system, the NVM can usually only be executed by one core (such as Core0), and when another core (such as Corel) enters the trap program branch, it is obvious that an NVM interface cannot be invoked directly by Corel; 4. the passive reset usually requires a certain time for wave filtering (such as the time for watchdog timeout), which is not conducive to rapid fault recovery. Therefore, the technical problem to be urgently solved by those skilled in the art is to design a solution through which a fault can be reset rapidly and a fault cause can be queried after reset.

### SUMMARY

In view of the defects, an embodiment of the present application discloses an exception reset monitoring method for a multi-core micro control unit, which can use a random access memory (RAM) to realize corresponding information recording and make fault recovery more rapid; and use active reset instead of passive reset to make a micro control unit reset faster and make software flow more controllable.

In a first aspect, the embodiment of the present application discloses an exception reset monitoring method for a multi-core micro control unit, comprising:
Acquiring exception program information of a corresponding program exception site after detecting that one processing core in a multi-core micro control unit has entered an exception program branch; the exception program information includes one or more of exception address information, exception time information, exception category information, exception core source information and exception program level;
Acquiring current processing core identity information associated with the exception program information, writing the processing core identity information and the exception program information into a specified storage area of a non-clear random access memory (an RAM which is not cleared after reset, hereinafter referred to as “non-clear RAM”), and executing micro control unit reset operation, wherein the specified storage area in the non-clear RAM is configured so that after micro control unit software is reset, data in the specified storage area remains as data stored before the reset.

As an optional embodiment, in the first aspect of the embodiment of the present application, the method also comprises the following step before executing micro control unit reset operation:

Adjusting a mark state of an exception identifier position to a first state, wherein the mark state includes a first state and a second state.

After fault information is recorded, the mark state need to be adjusted. In this way, it can be determined whether to perform a next operation based on mark state information when an application program is initialized next time, and thus overall fluency during run of a program can be improved.

As an optional embodiment, in the first aspect of the embodiment of the present application, the method also comprises the following steps after acquiring current processing core identity information associated with the exception program information:

Calculating a first check value of the processing core identity information and the exception program information according to a cyclic check algorithm, and writing the first check value into the specified storage area of the non-clear random access memory.

A CRC32 algorithm is used to perform redundancy calculation on corresponding information to obtain the check value, and the check value is used as basic comparison data for subsequent redundancy check. In this way, a CRC32 value of the non-clear RAM is recalculated after the software is reset, and by comparing with a CRC32 value recorded before the reset, whether the non-clear RAM has been tampered can be known. Therefore, accuracy of subsequent fault data output can be further improved.

As an optional embodiment, in the first aspect of the embodiment of the present application, the method also comprises the following steps after executing micro control unit reset operation:
Acquiring the processing core identity information and the exception program information of the specified storage area of the non-clear random access memory at a main processing core (Core0);
Calculating a second check value of the processing core identity information and the exception program information according to a cyclic check algorithm at the main processing core (Core0), comparing the second check value with the first check value stored in the non-clear random access memory, and after the comparison is passed, determining corresponding fault diagnosis codes and snapshot information according to the processing core identity information, the exception program information and set conditions;
Transmitting the fault diagnosis codes and the snapshot information to a diagnosis event management module to enable a user to acquire the corresponding fault diagnosis codes through a diagnosis interface.

Exception fault information can be analyzed and recorded by the above steps, and a corresponding diagnosis interface can be provided for a corresponding user to directly acquire corresponding fault diagnosis information, which greatly improves the possibility of analyzing a root fault cause.

As an optional embodiment, in the first aspect of the embodiment of the present application, the method also comprises the following steps after detecting that one processing core in a multi-core micro control unit has entered an exception program branch:
Determining the exception category information according to the exception program branch, wherein the exception category information is in at least two types;
Determining the exception program level according to the exception category information, wherein a fixed mapping relationship exists between each type of exception category information and the exception program level;
When the detected exception program level is a first exception level, acquiring first exception address information in a register EIPC and acquiring a first exception cause code in a register EIIC;
When the detected exception program level is a second exception level, acquiring second exception address information in a register FEPC and acquiring a second exception cause code in a register FEIC, respectively.

In specific implementation, the exception category information is associated with the exception program level, which makes it possible to map the corresponding exception levels no matter what type of exception occurs, and acquire the corresponding exception addresses and exception cause codes, which is convenient for subsequent information recording and simplified recording of exception categories based on actual structures.

As an optional embodiment, in the first aspect of the embodiment of the present application, the exception time information is acquired by the following steps:
Acquiring system time information after entering the exception program branch, and identifying the system time information as the exception time information, wherein the exception time information is timestamp information when an exception occurs.

The above steps are specific time acquisition steps, through which information of an exception occurring time point can be determined, and thus convenience of time information acquisition is improved.

As an optional embodiment, in the first aspect of the embodiment of the present application, a space size of the specified storage area is at least 200 bytes; and the non-clear RAM is configured to be shared by the multi-core micro control unit.

A random access memory (RAM) has the characteristics of high reading speed and autonomous allocation by users, which makes it possible to realize rapid data access and be shared by the multi-core micro control unit. By using a multi-core shared non-clear RAM, it can be ensured that one core processes a fault while other cores only record fault information. At the same time, it can be ensured that the fault information recorded is still retained after a fast reset due to the characteristic of “being not cleared”.

When setting a space of the specified storage area, a sufficient space can be reserved, because the RAM is generally much more abundant in resources and more flexible in allocation than an NVM.

In a second aspect, the embodiment of the present application discloses an exception reset monitoring device for a multi-core micro control unit, comprising:
An acquisition module: used for acquiring exception program information of a corresponding program exception site after detecting that one processing core in a multi-core micro control unit has entered an exception program branch; the exception program information includes one or more of exception address information, exception time information, exception category information, exception core source information and exception program level;
A storage module: used for acquiring current processing core identity information associated with the exception program information, writing the processing core identity information and the exception program information into a specified storage area of a non-clear RAM, and executing micro control unit reset operation, wherein the specified storage area in the non-clear RAM is configured so that after micro control unit software is reset, data in the specified storage area remains as data stored before the reset.

In a third aspect, the embodiment of the present application discloses an electronic device, comprising a memory which stores executable program codes and a processor which is coupled to the memory; the executable program codes stored in the memory are invoked by the processor to execute the exception reset monitoring method for a multi-core micro control unit disclosed in the first aspect of the embodiment of the present application.

In a fourth aspect, the embodiment of the present application discloses a computer readable storage medium, wherein a computer program is stored in the computer readable storage medium, and the computer program enables a computer to execute the exception reset monitoring method for a multi-core micro control unit disclosed in the first aspect of the embodiment of the present application.

Compared with the prior art, the embodiment of the present application has the following beneficial effects:

The exception reset monitoring method for a multi-core micro control unit in the embodiment of the present application is designed with the non-clear random access memory (non-clear RAM) instead of the NVM to allow that when an exception occurs during run of a whole program, exception information generated can be stored in a specified area of the non-clear RAM for data protection, and through reasonable design, data in a protected area will not be cleared during subsequent reset.

### DESCRIPTION OF DRAWINGS

To more clearly describe the technical solutions in the embodiments of the present application, the drawings required to be used in the embodiments will be simply presented below. Apparently, the drawings in the following description are merely some embodiments of the present application, and for those skilled in the art, other drawings can also be obtained according to these drawings without contributing creative labor.

FIG. 1 is a flow chart of an exception reset monitoring method for a multi-core micro control unit disclosed in an embodiment of the present application;

FIG. 2 is a specific flow chart of an exception reset monitoring method for a multi-core micro control unit disclosed in an embodiment of the present application;

FIG. 3 is a flow chart of fault analysis disclosed in an embodiment of the present application;

FIG. 4 is a flow chart of exception level determination and exception cause acquisition disclosed in an embodiment of the present application;

FIG. 5 is a diagram of an information recording process disclosed in an embodiment of the present application after software enters an exception program branch;

FIG. 6 is a flow chart of a method for keeping a non-clear RAM not cleared after reset disclosed in an embodiment of the present application;

FIG. 7 is a structural schematic diagram of an exception reset monitoring device for a multi-core micro control unit provided in an embodiment of the present application;

FIG. 8 is a structural schematic diagram of an electronic device provided in an embodiment of the present application.

### DETAILED DESCRIPTION

The technical solutions in the embodiments of the present application will be clearly and fully described below in combination with the drawings in the embodiments of the present application. Apparently, the described embodiments are merely part of the embodiments of the present application, not all of the embodiments. Based on the embodiments in the present application, all other embodiments obtained by those ordinary skilled in the art without contributing creative labor will belong to the protection scope of the present application.

It should be noted that the terms such as “first”, “second”, “third”, “fourth” and the like in the description and claims in the present application are used for distinguishing different objects rather than used for describing a special order. Terms of “comprise” and “have” as well as any other variant in the embodiments of the present application are intended to cover non-exclusive inclusion, for example, processes, methods, systems, products or devices including a series of steps or units are not limited to those steps or units clearly listed, but include other steps or units that are not listed clearly or are inherent to these processes, methods, products or devices.

When a program enters an exception program (TRAP) branch due to a MCU running fault, a watchdog cannot be fed by a normal program, and MCU reset (passive reset) is caused by watchdog timeout, so that software is reset to a normal state, which is a most common processing method for an MCU exception. In order to acquire a cause of an exception reset, fault information is usually recorded in a non-volatile memory (an NVM is used in an AUTOSAR architecture) after the software enters the TRAP branch; and fault analysis is performed by reading information acquired by the NVM after the software is reset. The NVM has inherent problems and is not suitable for an exception reset processing program; and the method of “passive reset” is not conducive to time control of software reset. The embodiments of the present application disclose an exception reset monitoring method, device, electronic device and storage medium for a multi-core micro control unit, which are designed with a non-clear random access memory to allow that when an exception occurs during run of a whole program, exception information generated can be stored in a specified area of the non-clear random access memory for data protection, and data in a protected area will not be cleared during subsequent reset.

### Embodiment 1

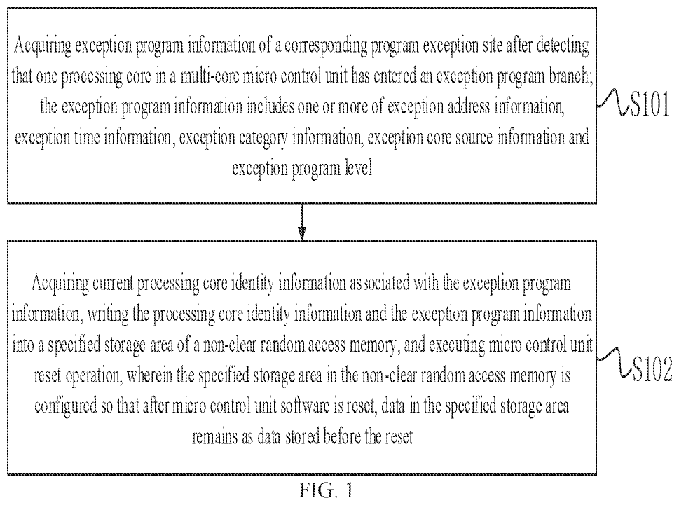

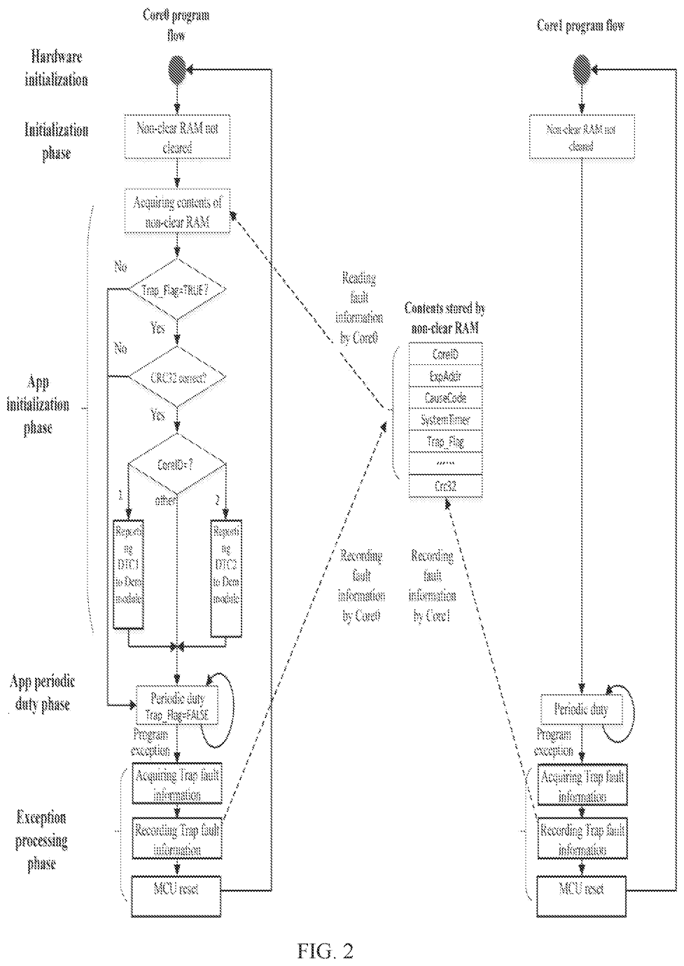

Referring to FIG. 1, FIG. 1 is a flow chart of an exception reset monitoring method for a multi-core micro control unit disclosed in an embodiment of the present application. An executive body of the method in the embodiment of the present application is composed of software or/and hardware, which can receive relevant information in a wired or/and wireless mode and send certain instructions. Of course, the executive body can also have certain processing and storage functions. The executive body can control multiple devices, such as a remote physical server or cloud server and related software, or a local host or server and related software that perform related operations on a device located somewhere. In some scenarios, the executive body can also control multiple storage devices, and the storage devices can be placed in the same place or in different places. As shown in FIG. 1 and FIG. 2, the exception reset monitoring method for a multi-core micro control unit comprises the following steps:
S101: acquiring exception program information of a corresponding program exception site after detecting that one processing core in a multi-core micro control unit has entered an exception program branch; the exception program information includes one or more of exception address information, exception time information, exception category information, exception core source information and exception program level;
S102: acquiring current processing core identity information associated with the exception program information, writing the processing core identity information and the exception program information into a specified storage area of a non-clear random access memory, and executing micro control unit reset operation, wherein the specified storage area in the non-clear random access memory is configured so that after micro control unit software is reset, data in the specified storage area remains as data stored before the reset.

In specific implementation, an exception condition may occur during run of an application program; when a core enters an exception program (TRAP) branch, an important aspect is to acquire related information of a program exception site. Such information includes exception address, exception time, exception category, exception core source (which core an exception is from), exception level, etc. The specific information that can be acquired varies from MCU to MCU.

In the embodiment of the present application, the “non-clear RAM” is used instead of the NVM to record TRAP-related information, so problems caused by inherent defects of the NVM is avoided; active reset is used instead of the passive reset to control software reset time and program flow direction; in this way, the software reset time can be controlled, and corresponding fault information will not be cleared after the reset, so stability of data storage can be ensured. In the embodiment of the present application, the non-clear random access memory refers to an RAM which is not cleared after reset, and a specific meaning is that after MCU software is reset, the non-clear RAM still maintains a value as that before reset.

Specifically, after software running in any MCU core enters the TRAP program branch, a large amount of fault-related information can be recorded into the non-clear RAM, and then the MCU can be actively reset by the software; the process usually takes a few microseconds.

More preferably, the method also comprises the following step before executing micro control unit reset operation:
Adjusting a mark state of an exception identifier position to a first state, wherein the mark state includes a first state and a second state.

After fault information is recorded, the mark state need to be adjusted. In this way, it can be determined whether to perform a next operation based on mark state information when an application program is initialized next time, and thus overall fluency during run of a program can be improved.

More preferably, the method also comprises the following steps after acquiring current processing core identity information associated with the exception program information:
Calculating a first check value of the processing core identity information and the exception program information according to a cyclic check algorithm, and writing the first check value into the specified storage area of the non-clear random access memory.

A CRC32 algorithm is used to perform redundancy calculation on corresponding information to obtain the check value, and the check value is used as basic comparison data for subsequent redundancy check. In this way, a CRC32 value of the non-clear RAM is recalculated after the software is reset, and by comparing with a CRC32 value recorded before the reset, whether the non-clear RAM has been tampered can be known. Therefore, accuracy of subsequent fault data output can be further improved.

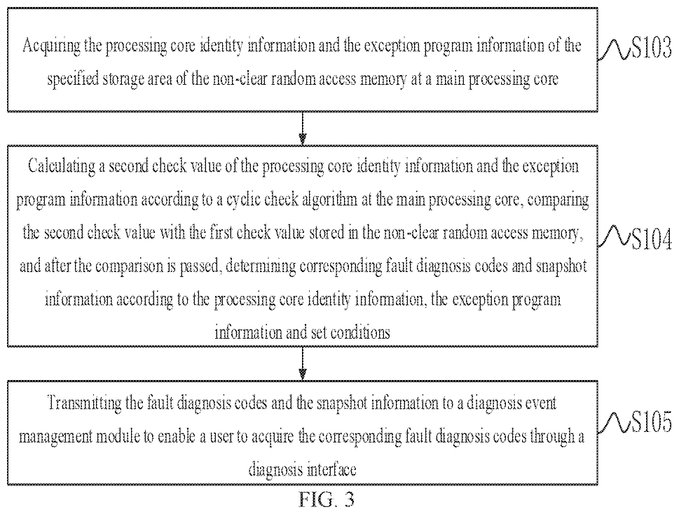

More preferably, FIG. 3 is a flow chart of fault analysis disclosed in an embodiment of the present application; as shown in FIG. 3, the method also comprises the following steps after executing micro control unit reset operation:
S103: acquiring the processing core identity information and the exception program information of the specified storage area of the non-clear random access memory at a main processing core;
S104: calculating a second check value of the processing core identity information and the exception program information according to a cyclic check algorithm at the main processing core, comparing the second check value with the first check value stored in the non-clear random access memory, and after the comparison is passed, determining corresponding fault diagnosis codes and snapshot information according to the processing core identity information, the exception program information and set conditions;
S105: transmitting the fault diagnosis codes and the snapshot information to a diagnosis event management module to enable a user to acquire the corresponding fault diagnosis codes through a diagnosis interface.

Exception fault information can be analyzed and recorded by the above steps, and a corresponding diagnosis interface can be provided for a corresponding user to directly acquire corresponding fault diagnosis information, which greatly improves overall convenience and universality of application scenarios.

After the software is reset and the information in the non-clear RAM is checked to be true by Core0, fault source (such as which core a fault is from), fault category, address of a faulty program, etc. can be extracted, the fault is reported to a Dem module according to the information, and a fault code can be read by the user through the diagnosis interface.

In the embodiment of the present application, Trap fault information analysis is performed in an App initialization phase, as shown in FIG. 2. Input of Trap fault information is the information reserved by the non-clear RAM, and output of the Trap fault information is DTC codes and the snapshot information to be reported to the Dem module. The number of the DTC codes corresponding to a Trap can be large or small, and can be allocated according to requirements of a system, which will not be described in detail herein. Specifically, first, Trap_Flag is judged to be TRUE or not, and the data in the non-clear RAM need to be analyzed only when Trap_Flag is TRUE; then the CRC32 value of the data in the non-clear RAM is judged to be correct or not, and the data need to be processed only when the CRC32 value is correct; finally, CRC is classified and snapshot data is allocated according to actual needs. If the DTC codes are set according to CoreId, two DTC codes can be set. A snapshot of the DTC codes can be selected from all or part of the information in the non-clear RAM. In this way, the information such as location and time of a program error and core to which the program error belongs can be judged by an automotive diagnosis engineer by reading the fault code and the snapshot thereof.

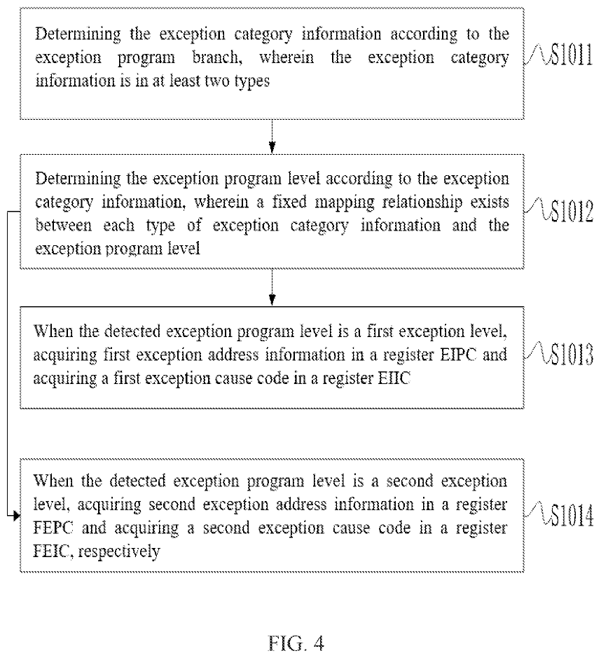

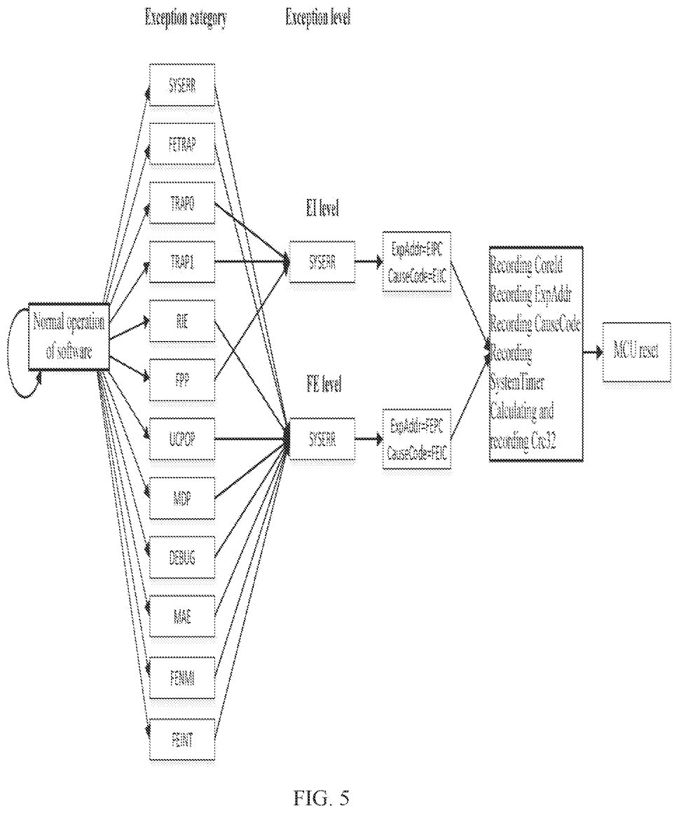

More preferably, FIG. 4 is a flow chart of exception level determination and exception cause acquisition disclosed in an embodiment of the present application; FIG. 5 is a diagram of an information recording process disclosed in an embodiment of the present application after software enters an exception program branch; As shown in FIG. 4 and FIG. 5, the method also comprises the following steps after detecting that one processing core in a multi-core micro control unit has entered an exception program branch:
S1011: determining the exception category information according to the exception program branch, wherein the exception category information is in at least two types;
S1012: determining the exception program level according to the exception category information, wherein a fixed mapping relationship exists between each type of exception category information and the exception program level;
S1013: when the detected exception program level is a first exception level, acquiring first exception address information in a register EIPC and acquiring a first exception cause code in a register EIIC;
S1014: when the detected exception program level is a second exception level, acquiring second exception address information in a register FEPC and acquiring a second exception cause code in a register FEIC, respectively.

In specific implementation, the exception category information is associated with the exception program level, which makes it possible to map the corresponding exception levels no matter what type of exception occurs, and acquire the corresponding exception addresses and exception cause codes, which is convenient for subsequent information recording and simplified recording of exception categories based on actual structures.

More preferably, the exception time information is acquired by the following steps:
Acquiring system time information after entering the exception program branch, and identifying the system time information as the exception time information, wherein the exception time information is timestamp information when an exception occurs.

The above steps are specific time acquisition steps, through which information of an exception occurring time point can be determined, and thus convenience of time information acquisition is improved.

In the embodiment of the present application, Renesas MCU RH850 P1H-C is taken as an example to illustrate a corresponding design solution. In Renesas MCU RH850 P1H-C, two exception levels EI and FE and 15 exception categories are mainly used. Each exception category has a separate exception program branch, i.e., each exception program branch will trigger a corresponding exception category. A fixed mapping relationship exists between the exception category and the exception program level; therefore, when a program has an exception and enters an exception program branch, the exception category thereof is also known. When the exception program level is EI, the exception address (ExpAddr) and the exception cause code (CauseCode) can be acquired in the register EIPC and the register EIIC, respectively; when the exception program level is FE, the exception address (ExpAddr) and the exception cause code (CauseCode) can be acquired in the register FEPC and the register FEIC, respectively.

In the embodiment of the present application, the exception time, i.e., the timestamp when the exception occurs, can be obtained by acquiring system time (SystemTimer) after entering the exception program branch. All the information acquired above is finally summarized and written into the non-clear RAM, along with the current core ID (indicating the core from which the program enters the Trap), and information of a Trap entering mark position (Trap_Flag) is adjusted to TRUE. Finally, the CRC32 value of all the written information is calculated and written into an end part of the non-clear RAM. In this way, the CRC32 value of the non-clear RAM is recalculated after the software is reset, and by comparing with the CRC32 value recorded before the reset, whether the non-clear RAM has been tampered can be known. A process of acquiring the Trap fault information is shown in FIG. 5.

More preferably, a space size of the specified storage area is at least 200 bytes; and the non-clear random access memory is configured to be shared by the multi-core micro control unit.

A random access memory has the characteristics of high reading speed and convenient operation, which makes the random access memory possible to be shared by the multi-core micro control unit. By using a multi-core shared non-clear RAM, it can be ensured that one core processes a fault while other cores only record fault information. When setting a space of the specified storage area, an adequate space can be reserved appropriately for the convenience of subsequent solution expansion, for example, increasing the number of the cores and the amount of the fault information.

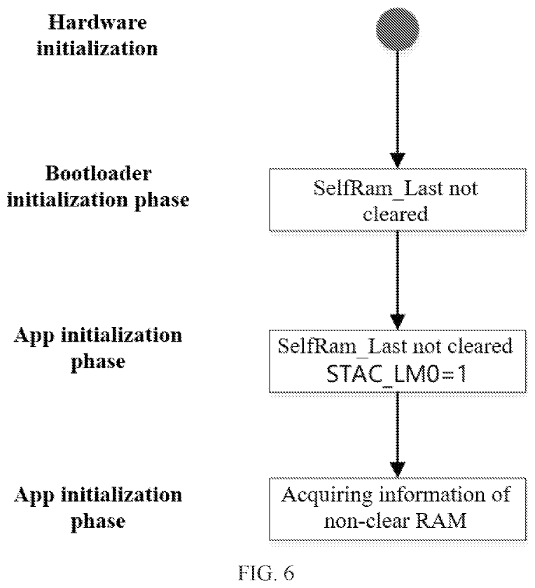

In the embodiment of the present application, the non-clear RAM refers to a segment of RAM address block with contents not to be reset to a default value after the software is reset. The non-clear RAM needs to be realized through a combination of the software and the hardware. From MCU reset to APP use of the non-clear RAM, it needs to go through three phases: RAM module reset (hardware guarantee), Bootloader software initialization of RAM (software guarantee), and APP initialization of RAM (software guarantee). Only when the data in the specified area of the RAM is not cleared during the three phases can APP diagnostic software acquire TRAP information before the reset in the non-clear RAM. MCU reset is divided into hard reset, system reset and software reset; only when soft reset is selected and a register STAC_LM0=1, will the last 1K of the space of SelfRam (hereinafter referred to as SelfRam_Last) not be reset to a default value by the hardware after the reset. In Bootloader and App initialization phases, the SelfRam_Last is not initialized, and the non-clear RAM can be designed as shown in FIG. 6. In other words, the Bootloader software and the application program are provided with a corresponding command segment, respectively; when executed, the two command segments will not perform a clear operation on the data in the specified storage area of the non-clear RAM, but will only perform a clear operation on the data in areas outside the specified storage area in the non-clear RAM, so specific data information can be acquired in a subsequent application program initialization phase.

In the embodiment of the present application, the “non-clear RAM” is used instead of the NVM to record TRAP-related information, so problems caused by inherent defects of the NVM is avoided; active reset is used instead of the passive reset to control software reset time and program flow direction; by using a multi-core shared non-clear RAM, it can be ensured that one core processes a fault while other cores only record fault information; and CheckSum is used to ensure consistency of the data of the non-clear RAM. To realize the exception monitoring method, first, it is necessary to design the “non-clear RAM”; second, it is necessary to acquire as much critical information as possible after entering the Trap; finally, it is necessary to analyze the fault cause, obtain the fault code and snapshot information, and report the code and the information to the Dem module after the software is reset. A software flow is shown in FIG. 2 below.

The design of the solution of the embodiment of the present application comprises three key steps, i.e., non-clear RAM design, Trap fault information acquisition and Trap fault information analysis. Although the developed exception reset monitoring method can theoretically be used for any automotive-grade MCU, corresponding fault acquisition can be carried out according to different MCUs in specific implementation because a software exception (TRAP) is strongly related to the MCU itself, to be specific, the TRAP types and TRAP generating mechanisms of different MCUs are different.

The solution of the embodiment of the present application has the following advantages: first, by using the RAM instead of the NVM to record information, fault recovery is more rapid; second, by using the RAM with a relatively abundant resource instead of the NVM, more fault information can be recorded, and analysis is convenient; third, by using active reset instead of passive reset, MCU reset is faster, and the software flow is more controllable; fourth, an analyzed fault is report is to the Dem module, rather than being stored directly in the NVM, which is more in line with standards for automotive software.

The exception reset monitoring method for a multi-core micro control unit in the embodiment of the present application is designed with the non-clear random access memory to allow that when an exception occurs during run of a whole program, exception information generated can be stored in a specified area of the non-clear random access memory for data protection, and data in a protected area will not be cleared during subsequent reset.

### Embodiment 2

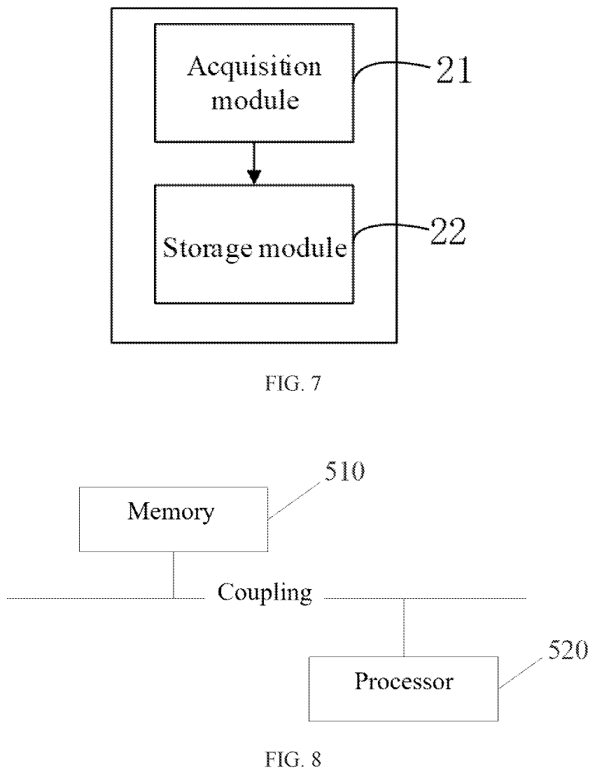

Referring to FIG. 7, FIG. 7 is a structural schematic diagram of an exception reset monitoring device for a multi-core micro control unit disclosed in an embodiment of the present application. As shown in FIG. 7, the exception reset monitoring device for a multi-core micro control unit can comprise:
An acquisition module 21: used for acquiring exception program information of a corresponding program exception site after detecting that one processing core in a multi-core micro control unit has entered an exception program branch; the exception program information includes one or more of exception address information, exception time information, exception category information, exception core source information and exception program level;
A storage module 22: used for acquiring current processing core identity information associated with the exception program information, writing the processing core identity information and the exception program information into a specified storage area of a non-clear RAM, and executing micro control unit reset operation, wherein the specified storage area in the non-clear RAM is configured so that after micro control unit software is reset, data in the specified storage area remains as data stored before the reset.

The exception reset monitoring method for a multi-core micro control unit in the embodiment of the present application is designed with the non-clear random access memory to allow that when an exception occurs during run of a whole program, exception information generated can be stored in a specified area of the non-clear random access memory for data protection, and data in a protected area will not be cleared during subsequent reset.

### Embodiment 3

Referring to FIG. 8, FIG. 8 is a structural schematic diagram of an electronic device disclosed in an embodiment of the present application. The electronic device can be a computer, a server, etc. Of course, in certain cases, the electronic device can also be an intelligent device such as a cellphone, a tablet computer and a monitoring terminal, as well as an image collecting device with a processing function. As shown in FIG. 8, the electronic device can comprise: A memory 510 which stores executable program codes;
A processor 520 which is coupled to the memory 510;
The executable program codes stored in the memory 510 are invoked by the processor 520 to execute some or all steps in the exception reset monitoring method for a multi-core micro control unit in embodiment 1.

The embodiment of the present application discloses a computer readable storage medium, wherein a computer program is stored in the computer readable storage medium, and the computer program enables a computer to execute some or all steps in the exception reset monitoring method for a multi-core micro control unit in embodiment 1.

The embodiment of the present application also discloses a computer program product, wherein when the computer program product runs on a computer, the computer is enabled to execute some or all steps in the exception reset monitoring method for a multi-core micro control unit in embodiment 1.

The embodiment of the present application also discloses an application publishing platform, wherein the application publishing platform is used for publishing the computer program product, and when the computer program product runs on a computer, the computer is enabled to execute some or all steps in the exception reset monitoring method for a multi-core micro control unit in embodiment 1.

In various embodiments of the present application, it should be understood that values of serial numbers of the processes do not imply a necessary execution order, and the execution order of the processes shall be determined by functions and internal logics thereof, and shall not constitute any limitation to the implementation process of the embodiments of the present application.

Units described as separated components may be or may not be separated physically, and components displayed as units may be or may not be physical units, that is, the components can be located at one place or can be distributed on a plurality of network units. The purpose of the solution of the present embodiment can be achieved by selecting some or all units according to actual needs.

In addition, each functional unit in various embodiments of the present application can be integrated in a processing unit, or each unit can physically exist individually, or two or more than two units can be integrated in one unit. The integrated unit can be realized in a form of hardware or can be realized in a form of a software functional unit.

If realized in the form of the software functional unit and sold or used as an independent product, the integrated unit can be stored in a computer accessible memory. Based on such understanding, the technical solutions in the present application can be reflected in a form of a software product in essence or in a part of making a contribution to the prior art. The computer software product is stored in a memory, including several requests to enable one computer device (may be a personal computer, a server or a network device, etc.) to execute some or all steps of the methods of various embodiments of the present application.

In the embodiments provided in the present application, it should be understood that “a B corresponding to an A” indicates that the B is associated with the A, and the B can be determined according to the A. However, it should also be understood that determining the B according the A does not mean that the B is determined according the A only, but that the B can also be determined according the A and/or other information.

Those skilled in the art can understand that some or all steps in various methods of the embodiments can be completed through programs to instruct relevant hardware. The programs can be stored in a computer readable storage medium. The storage medium includes read-only memory (ROM), random access memory (RAM), programmable read-only memory (PROM), erasable programmable read-only memory (EPROM), one-time programmable read-only memory (OTPROM), electrically-erasable programmable read-only memory (EEPROM), compact disc read-only memory (CD-ROM) or other optical disk memory, disk memory, magnetic tape memory, or any other computer readable medium that can be used to carry or store data.

The exception reset monitoring method, device, electronic device and storage medium for a multi-core micro control unit disclosed in the embodiments of the present application are described in detail above. Specific individual cases are applied herein for elaborating the principle and embodiments of the present application. The illustration of the above embodiments is merely used for helping to understand the method of the present application and the core thought thereof. Meanwhile, for those ordinary skilled in the art, specific embodiments and the application scope may be changed in accordance with the thought of the present application. In conclusion, the contents of the description shall not be interpreted as a limitation to the present application.

1. An exception reset monitoring method for a multi-core micro control unit, comprising:
acquiring exception program information of a corresponding program exception site after detecting that one processing core in a multi-core micro control unit has entered an exception program branch; the exception program information includes one or more of exception address information, exception time information, exception category information, exception core source information and exception program level;
acquiring current processing core identity information associated with the exception program information, writing the processing core identity information and the exception program information into a specified storage area of a non-clear random access memory, and executing micro control unit reset operation, wherein the non-clear random access memory refers to an RAM which is not cleared after reset, the specified storage area in the non-clear random access memory is configured so that after micro control unit software is reset, data in the specified storage area remains as data stored before the reset.

2. The exception reset monitoring method for a multi-core micro control unit according to claim 1, wherein the method also comprises the following step before executing micro control unit reset operation:
adjusting a mark state of an exception identifier position to a first state, wherein the mark state includes a first state and a second state.

3. The exception reset monitoring method for a multi-core micro control unit according to claim 2, wherein the method also comprises the following steps after acquiring current processing core identity information associated with the exception program information:
calculating a first check value of the processing core identity information and the exception program information according to a cyclic check algorithm, and writing the first check value into the specified storage area of the non-clear random access memory.

4. The exception reset monitoring method for a multi-core micro control unit according to claim 3, wherein the method also comprises the following steps after executing micro control unit reset operation:
acquiring the processing core identity information and the exception program information of the specified storage area of the non-clear random access memory at a main processing core;
calculating a second check value of the processing core identity information and the exception program information according to a cyclic check algorithm at the main processing core, comparing the second check value with the first check value stored in the non-clear random access memory, and after the comparison is passed, determining corresponding fault diagnosis codes and snapshot information according to the processing core identity information, the exception program information and set conditions;
transmitting the fault diagnosis codes and the snapshot information to a diagnosis event management module to enable a user to acquire the corresponding fault diagnosis codes through a diagnosis interface.

5. The exception reset monitoring method for a multi-core micro control unit according to claim 1, wherein the method also comprises the following steps after detecting that one processing core in a multi-core micro control unit has entered an exception program branch:
determining the exception category information according to the exception program branch, wherein the exception category information is in at least two types;
determining the exception program level according to the exception category information, wherein a fixed mapping relationship exists between each type of exception category information and the exception program level;
when the detected exception program level is a first exception level, acquiring first exception address information in a first register and acquiring a first exception cause code in a second register;
when the detected exception program level is a second exception level, acquiring second exception address information in a third register and acquiring a second exception cause code in a fourth register, respectively.

6. The exception reset monitoring method for a multi-core micro control unit according to claim 1, wherein the exception time information is acquired by the following steps:
acquiring system time information after entering the exception program branch, and identifying the system time information as the exception time information, wherein the exception time information is timestamp information when an exception occurs.

7. The exception reset monitoring method for a multi-core micro control unit according to claim 1, wherein a space size of the specified storage area is at least 200 bytes; and the non-clear random access memory is configured to be shared by the multi-core micro control unit.

8. (canceled)

9. An electronic device, comprising a memory which stores executable program codes and a processor which is coupled to the memory; the executable program codes stored in the memory are invoked by the processor to execute the exception reset monitoring method for a multi-core micro control unit in claim 1.

10. A non-transitory computer readable storage medium, wherein a computer program is stored in the computer readable storage medium, and the computer program enables a computer to execute the exception reset monitoring method for a multi-core micro control unit in claim 1.

11. An electronic device, comprising a memory which stores executable program codes and a processor which is coupled to the memory; the executable program codes stored in the memory are invoked by the processor to execute the exception reset monitoring method for a multi-core micro control unit in claim 2.

12. An electronic device, comprising a memory which stores executable program codes and a processor which is coupled to the memory; the executable program codes stored in the memory are invoked by the processor to execute the exception reset monitoring method for a multi-core micro control unit in claim 3.

13. An electronic device, comprising a memory which stores executable program codes and a processor which is coupled to the memory; the executable program codes stored in the memory are invoked by the processor to execute the exception reset monitoring method for a multi-core micro control unit claim 4.

14. A non-transitory computer readable storage medium, wherein a computer program is stored in the computer readable storage medium, and the computer program enables a computer to execute the exception reset monitoring method for a multi-core micro control unit in claim 2.

15. A non-transitory computer readable storage medium, wherein a computer program is stored in the computer readable storage medium, and the computer program enables a computer to execute the exception reset monitoring method for a multi-core micro control unit in claim 3.

16. A non-transitory computer readable storage medium, wherein a computer program is stored in the computer readable storage medium, and the computer program enables a computer to execute the exception reset monitoring method for a multi-core micro control unit in claim 4.
